(19) United States
(12) Patent Application Publication
(10) Pub. No.: US 2011/0038014 A1
(43) Pub. Date: Feb. 17, 2011

(54) METHOD AND APPARATUS FOR GENERATING IMAGE DATA OF DOCUMENT, AND COMPUTER-READABLE STORAGE MEDIUM FOR COMPUTER PROGRAM

(75) Inventor: Atsushi ITO, Yawata-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/853,919

(22) Filed: Aug. 10, 2010

(30) Foreign Application Priority Data
Aug. 17, 2009 (JP) 2009-188781

(51) Int. Cl. H04N 1/00

(52) U.S. Cl. 358/406

(57) ABSTRACT

A method is provided for generating image data of a document by reading an image depicted on the document having a plurality of surfaces to be read. The method includes: reading, by an image reader, a surface image that is an image depicted on each of the surfaces; detecting, by an error detector, a faulty surface that is a surface of the plurality of surfaces of the document and corresponds to a scanned image on which an error occurs, the scanned image being obtained by reading the surface image; reading, by the image reader, the surface image repeatedly until the error is not detected; and generating, by an image data generating portion, the image data by merging data on the plurality of the scanned images on which the error is not detected and which correspond to the surfaces.

This application is based on Japanese patent application No. 2009-188781 filed on Aug. 17, 2009, the contents of which are hereby incorporated by reference.

### BACKGROUND OF THE INVENTION

1. Field of the Invention

The present invention relates to a method, an apparatus, and the like for scanning a document.

2. Description of the Related Art

Image processing apparatuses called “multifunction devices”, “Multi-Function Peripherals (MFPs)”, or the like have recently come into widespread use in offices of business, and have recently become popular in homes. Such image processing apparatuses integrate a copying function, a network printing (PC printing) function, a faxing function, a scanning function, and so on, into a single unit.

Further, in recent years, a scanner has often been used to scan document data depicted on paper to create electronic data thereof, and the electronic data created has been saved. This reduces a space in which the document data is to be saved as compared to conventional techniques.

In the case where a plurality of persons send and receive document data depicted on paper, it has become common to scan the document data on paper by a scanner to create electronic data thereof, and transmit the electronic data via a communication line from one end to the other, instead of copying the paper carrying thereon the document data onto a separate sheet of paper to transport the resulting copy from one end to the other. This makes it possible to reduce the cost of transportation and to send/receive the document data depicted on paper more quickly than with conventional techniques.

An Automatic Document Feeder (ADF) feeds a plurality of sheets of paper to a scanner consecutively. Even for the case of a large amount of document data depicted on a plurality of sheets of paper, the use of the ADF eliminates the need for an operator to place each of the sheets of paper on a document tray, and makes it possible to scan the document data on paper and to create electronic data thereof.

In the meantime, when a plurality of sheets of paper are consecutively fed to a scanner and the scanner scans document data depicted on the sheets of paper, an error (failure) may occur partly in images obtained through scanning the sheets of paper. As with this case, when document data depicted on the both surfaces of a sheet of paper is scanned, an error may occur in an image obtained by the scanning and corresponding to one of the surfaces of the sheet of paper.

An apparatus disclosed in Japanese Laid-open Patent Publication No. 2006-245953 performs scanning without stopping feeding even when a paper-feed error is detected during consecutive scanning, and informs a user of an error image after the scanning.

When an error is detected, an operator may eliminate the cause of the error, and make the apparatus to perform a scanning process once again from the beginning. Alternatively, when an error is detected, the operator may make the apparatus to perform a scanning process, once again, only on a sheet of paper for which the error has been detected, and, replace, among data obtained through the first scanning process before the detection of the error, data of the sheet of paper for which the error has been detected with data obtained by the further scanning process after the detection of the error.

According to the former method, the operation is very simple so that the operator does not have to use his/her mind. The method involves, however, scanning again document data on all the sheets of paper, even including paper for which no errors have been detected. Thus, the former method is not an efficient method.

On the other hand, according to the latter method, the operator has to extract the target paper from a plurality of sheets of paper to perform a scanning process once again, and put back the target paper in place after the further scanning process. The operator also has to update image data by using an application such as an image editor. This imposes a burden on the operator, and a mistake may occur during the operation.

### SUMMARY

The present disclosure is directed to solve the problems pointed out above, and therefore, an object of an embodiment of the present invention is to obtain an error-free scan result for images depicted on a plurality of surfaces of a plurality of sheets of paper more easily than is conventionally possible.

According to an aspect of the present invention, a method is provided for generating image data of a document by reading an image depicted on the document having a plurality of surfaces to be read. The method includes a first step of reading, by an image reader, a surface image that is an image depicted on each of the plurality of surfaces, a second step of detecting, by an error detector, a faulty surface that is a surface of the plurality of surfaces of the document and corresponds to a scanned image on which an error occurs, the scanned image being obtained by reading the surface image, a third step of reading, by the image reader, the surface image repeatedly until the error is not detected, and a fourth step of generating, by an image data generating portion, the image data by merging data on the plurality of the scanned images on which the error is not detected and which correspond to the plurality of surfaces.

Preferably, the first step includes placing the plurality of surfaces in the image reader by feeding the document successively to the image reader by an automatic document feeder, and reading, by the image reader, the surface image depicted on said each of the plurality of surfaces, and the third step includes placing the plurality of surfaces in the image reader by feeding the document successively to the image reader by the automatic document feeder, reading, by the image reader, only the surface image depicted on the faulty surface, and skipping reading the surface images depicted on the plurality of surfaces except the surface image depicted on the faulty surface.

Preferably, the method further includes a fifth step of feeding, by a document feedback mechanism, the document to the automatic document feeder after the image reader reads the surface image depicted on said each of the plurality of surfaces.

Preferably, the third step includes changing conditions depending on the error found on the scanned image corresponding to the faulty surface, and reading the surface image depicted on the faulty surface by the image reader.

These and other characteristics and objects of the present invention will become more apparent by the following descriptions of preferred embodiments with reference to drawings.

### BRIEF DESCRIPTION OF THE DRAWINGS

FIG. 1 is a diagram illustrating an example of the overall configuration of a network system.

FIG. 2 is a diagram illustrating an example of the hardware configuration of an image forming apparatus.

FIG. 3 is a diagram illustrating an example of the functional configuration of an image forming apparatus.

FIG. 4 is a diagram illustrating an example of a page image state storage portion.

FIGS. 5A-5C are diagrams illustrating examples of the type of an error.

FIG. 6 is a flowchart illustrating an example of the overall processing flow of an image forming apparatus.

FIGS. 7A and 7B are diagrams depicting an example of steps for generating an image file.

FIGS. 8A and 8B are diagrams depicting an example of steps for generating an image file.

### DESCRIPTION OF THE PREFERRED EMBODIMENTS

An embodiment of the present invention is described below with reference to drawings.

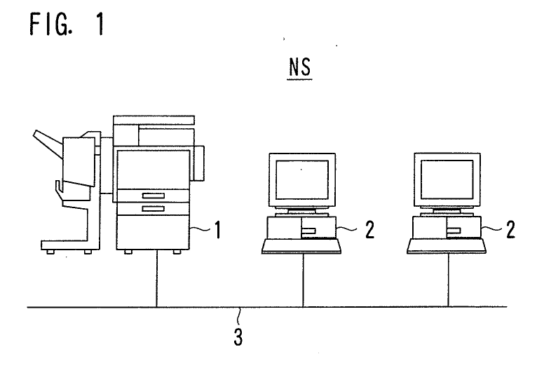

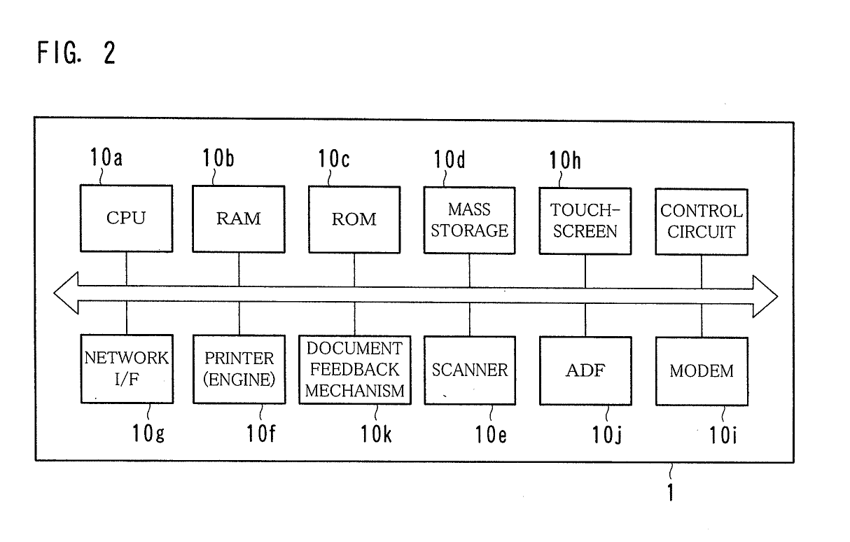

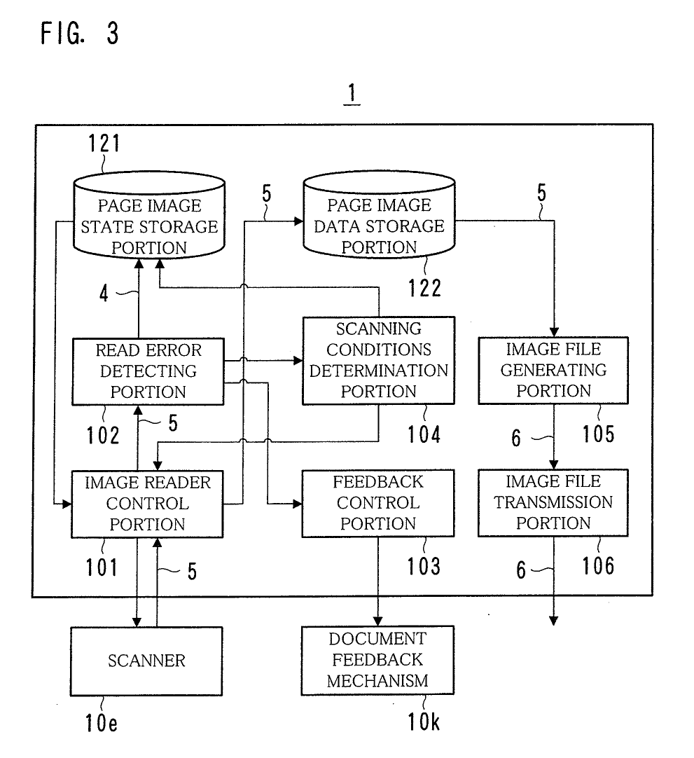

FIG. 1 is a diagram illustrating an example of the overall configuration of a network system NS; FIG. 2 is a diagram illustrating an example of the hardware configuration of an image forming apparatus 1; and FIG. 3 is a diagram illustrating an example of the functional configuration of the image forming apparatus 1.

Referring to FIG. 1, the network system NS is configured of the image forming apparatus 1, one or more terminals 2, a communication line 3, and so on. The image forming apparatus 1 and the individual terminals 2 are connectable to one another via the communication line 3. Examples of the communication line 3 are a so-called Local Area Network (LAN), the Internet, a public line, and a dedicated line.

The network system NS is installed in buildings of organizations such as business offices or public offices. A member belonging to such an organization (hereinafter referred to as a “user”) uses the network system NS. In particular, the user can use the network system NS of this embodiment to convert images depicted on a plurality of sheets of paper into electronic data with the occurrence of an error (failure) reduced more easily than is conventionally possible. The mechanism thereof is described below.

The image forming apparatus 1 is an image processing apparatus generally called a multifunction device or a Multi Function Peripheral (MFP). The image forming apparatus 1 is a device that integrates a variety of functions, such as copying, PC printing (network printing), faxing, scanning, box functions, an electronic mail communication function, and so on, into a single unit.

Referring to FIG. 2, the image forming apparatus 1 is configured of a Central Processing Unit (CPU) 10a, a Random Access Memory (RAM) 10b, a Read-Only Memory (ROM) 10c, a mass storage 10d, a scanner 10e, a printer 10f, a network interface 10g, a touchscreen 10h, a modem 10i, an Automatic Document Feeder (ADF) 10j, a document feedback mechanism 10k, a control circuit, and so on.

The ADF 10j is a device to feed each sheet of paper placed thereon to the scanner 10e.

The scanner 10e is a device to read images printed on paper supplied by the ADF 10j, i.e., images such as photographs, characters, drawings, diagrams, and the like, and create image data thereof.

The document feedback mechanism 10k serves to feed, to the ADF 10j, a sheet of paper that has been subjected to the process by the scanner 10e.

The printer 10f serves to print, onto paper, an image obtained by scanning with the scanner 10e or an image included in image data received from another device.

The touchscreen 10h displays, for example, a screen for giving a message or instructions to a user, a screen for the user to enter a process command and process conditions, and a screen displaying the result of a process performed by the CPU 10a. The touchscreen 10h also detects a position thereof touched by the user with his/her finger and sends a signal indicating the result of the detection to the CPU 10a.

The network interface 10g is a Network Interface Card (NIC) for communicating with another device such as the terminal 2 according to Transmission Control Protocol/Internet Protocol (TCP/IP) or another protocol via the communication line 3.

The modem 10i is a device for transmitting image data via a fixed-line telephone network to another facsimile terminal and vice versa based on a protocol such as G3.

Referring to FIG. 3, the ROM 10c or the mass storage 10d stores programs for implementing functions of an image reader control portion 101, a read error detecting portion 102, a feedback control portion 103, a scanning conditions determination portion 104, an image file generating portion 105, an image file transmission portion 106, a page image state storage portion 121, a page image data storage portion 122, and the like. These programs are loaded into the RAM 10b as necessary, whereupon the programs are executed by the CPU 10a. An example of the mass storage 10d is a hard disk or a flash memory.

The whole or a part of the functions of the individual portions illustrated in FIG. 3, and the like may be implemented merely by hardware such as a circuit.

A driver for the image forming apparatus 1 and an application for creating or editing an image are installed on the terminal 2. The user operates the terminal 2 to prepare an image and causes the image forming apparatus 1 to print the image onto paper. The user also operates the image forming apparatus 1 to scan an image depicted on paper, to convert the image obtained through the scanning into electronic data, and to transfer the electronic data to the terminal 2.

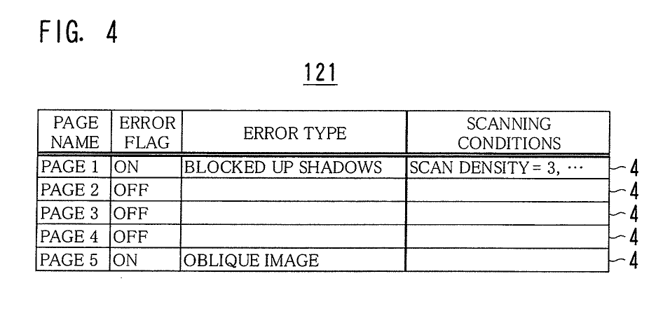

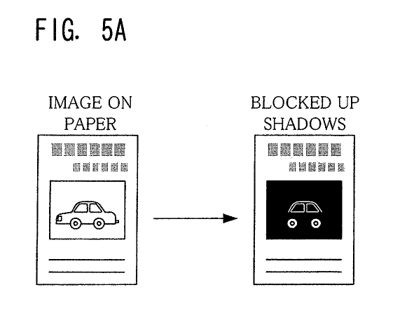

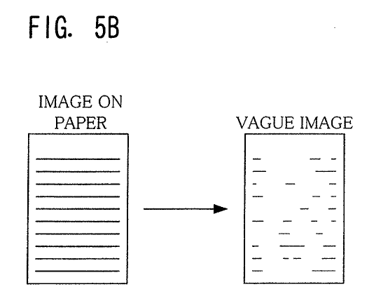

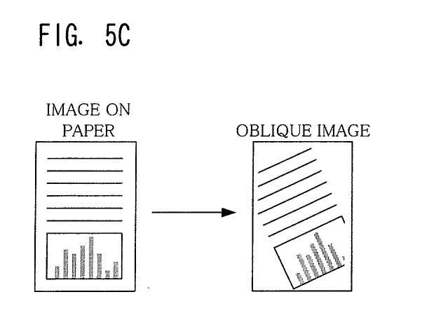

FIG. 4 is a diagram illustrating an example of the page image state storage portion 121, and FIGS. 5A-5C are diagrams illustrating examples of the type of an error.

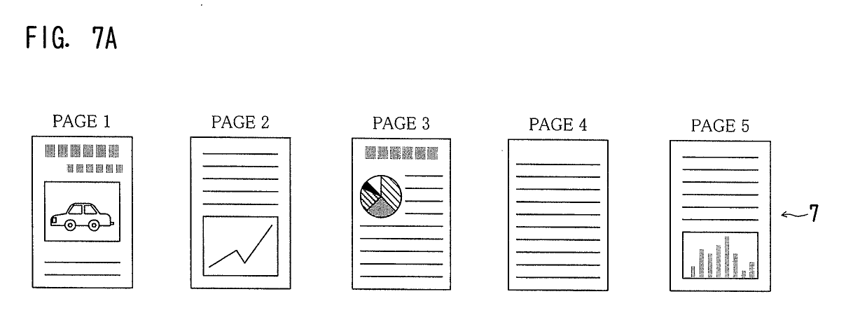

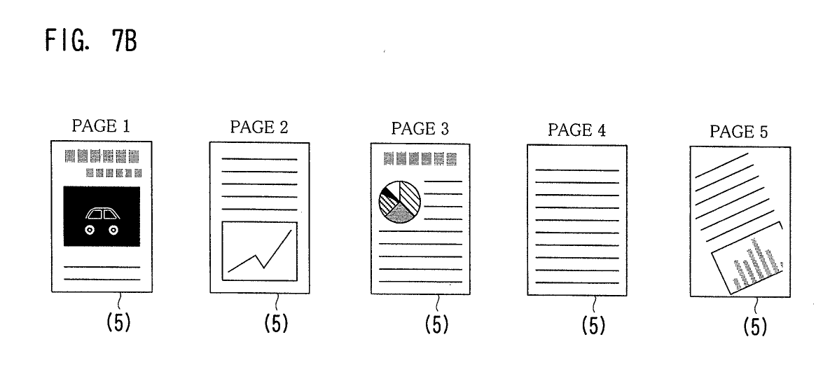

The details of processes performed by the individual portions of the image forming apparatus 1 as shown in FIG. 3 are described below, taking an example in which images carried on a document 7 having five pages (see FIG. 7A) are scanned and the resulting electronic data of the document 7 is sent to the terminal 2. Note that here an image, which corresponds to the contents of the document 7, is depicted only on one surface of each sheet of paper. In short, an image-carrying surface of the document, i.e., a surface to be scanned, is one face of the paper rather than both faces thereof. One-page content is depicted on one image-carrying surface of the document. Accordingly, image-carrying surfaces of the document corresponding to the first sheet, the second sheet, and the fifth sheet are hereinafter referred to as “Page 1”, “Page 2”, . . . , and “Page 5”, respectively.

The user places the document 7 in the ADF 10j and operates the touchscreen 10h to give the image forming apparatus 1a command to scan the images on the document 7. At this time, the user specifies a transmission destination of a file to be obtained as a result of the scanning of the document 7.

When the image forming apparatus 1 receives the scan command given by the user, the image reader control portion 101 shown in FIG. 3 controls the scanner 10e in such a manner that images on the individual pages of the document 7 are sequentially scanned. The image reader control portion 101 also controls the scanner 10e to scan, once again, an image depicted on a page for which the read error detecting portion 102, which will be described later, has detected the occurrence of an error.

Referring to FIG. 4, the page image state storage portion 121 stores, therein, page state information 4 for each page of the document 7 that has been scanned by the scanner 10e.

As for the page state information 4 for a certain page, the field of a “page name” indicates an identifier of the corresponding page. The pages of the document 7 are given page names such as “Page 1”, “Page 2”, and so on in the order in which images corresponding to the pages have been scanned by the scanner 10e.

The field of an “error flag” indicates whether or not an error has been detected in the corresponding page. The field of an “error type” indicates the type of an error that has been detected in the corresponding page. The field of “scanning conditions” indicates conditions to be used when an image of the corresponding page is scanned.

The initial value of the error flag is, for example, “NULL”, but neither “ON” indicating that an error has been detected, nor “OFF” indicating that no errors have been detected. The initial value of the error type is also “NULL”. The initial value of the scanning conditions is scanning conditions set as a default in the image forming apparatus 1, e.g., conditions such as a scan density or a resolution. Alternatively, the initial value of the scanning conditions may be conditions specified by the user before a scanning process is started.

A process for generating the page state information 4 and a process for updating the same will be described in due order.

Referring back to FIG. 3, the page image data storage portion 122 stores, therein, image data 5 of an image on each page obtained by the scanner 10e. Note that the scanning process is performed once again on a page for which the read error detecting portion 102 has detected an error. If no errors are detected in an image obtained by the further scanning process, the existing (old) image data 5 for the page is deleted from the page image data storage portion 122, and instead, image data 5 for the image which has been obtained by the further scanning process and for which no errors have been detected is newly stored in the page image data storage portion 122.

The read error detecting portion 102 checks images on the individual pages obtained by scanning with the scanner 10e, and detects whether or not errors occur in the individual images. If such an error is found, then the read error detecting portion 102 detects the type of the error. In this embodiment, the read error detecting portion 102 detects three types of errors, i.e., blocked up shadows, a vague image, and an oblique image.

As shown in FIG. 5A, the “blocked up shadows” mean that a part equal to or larger than a predetermined area in an image obtained by scanning a page is blacken.

As shown in FIG. 5B, the “vague image” means that the entire image obtained by scanning a page is blurred and whitish.

An image shown in FIG. 5C corresponds to the “oblique image”. To be specific, an image on paper is scanned under a state in which a predetermined side of the paper and a predetermined side of a glass surface of the scanner 10e do not make an appropriate angle, and they are obliquely rotated relative to each other.

Known techniques may be used to detect which type of the error, i.e., blocked up shadows, the vague image, and the oblique image, the image obtained by scanning a page using the scanner 10e correspond to. For example, a group of contiguous pixels having a black density equal to or larger than a predetermined value is searched for. Then, if the amount of such contiguous pixels is a predetermined number or more, it is determined that blocked up shadows appear. Further, if the white density of the entire page is equal to or lower than a predetermined value, it is determined that the image is obscure, i.e., the image corresponds to the vague image. Further, a rectangular area is detected in an image obtained by the scanning. Then, if the bottom of the rectangular area inclines from the reference line segment by a predetermined angle or more, it is determined that the image is oblique. Other than those described above, there is known another method of detecting these errors based on a histogram.

If the read error detecting portion 102 detects an error in a page, then the value of the “error flag” field in the page state information 4 (see FIG. 4) corresponding to the page is updated with “ON”, and then the value of the “error type” is updated with the error type detected. Otherwise, the value of the “error flag” field is updated with “OFF”.

Referring back to FIG. 3, the feedback control portion 103 controls the document feedback mechanism 10k in such a manner that, when the document 7 needs scanning once again, i.e., when the read error detecting portion 102 detects an error, the document 7 scanned by the scanner 10e is supplied to the document feedback mechanism 10k. In short, the feedback control portion 103 controls the document feedback mechanism 10k to supply the document 7 back to the ADF 10j.

If the read error detecting portion 102 detects an error, then the scanning conditions determination portion 104 determines conditions under which a page corresponding to the error is to be scanned once again. For example, if the read error detecting portion 102 detects, as the error, blocked up shadows, then the scanning conditions determination portion 104 determines, as conditions of a scan density to be used when the page is scanned once again, a scan density lower than, by a predetermined value, the scan density that has been used for scanning the page for which the blocked up shadows have been detected. Alternatively, if the read error detecting portion 102 detects, as the error, a vague image, then the scanning conditions determination portion 104 determines, as conditions of a scan density to be used when the page is scanned once again, a scan density higher than, by a predetermined value, the scan density that has been used for scanning the page for which the vague image has been detected.

In this way, the scanning conditions of the page state information 4 corresponding to the page are updated with the conditions determined as described above.

The image file generating portion 105 merges (combines) image data 5 corresponding to images for which no errors are found in the individual pages of the document 7 with one another, and converts the resultant into a predetermine format of data, e.g., PDF data or TIFF data, so that the image file 6 is generated.

The image file transmission portion 106 sends the image file 6 generated by the image file generating portion 105 to the transmission destination specified by the user.

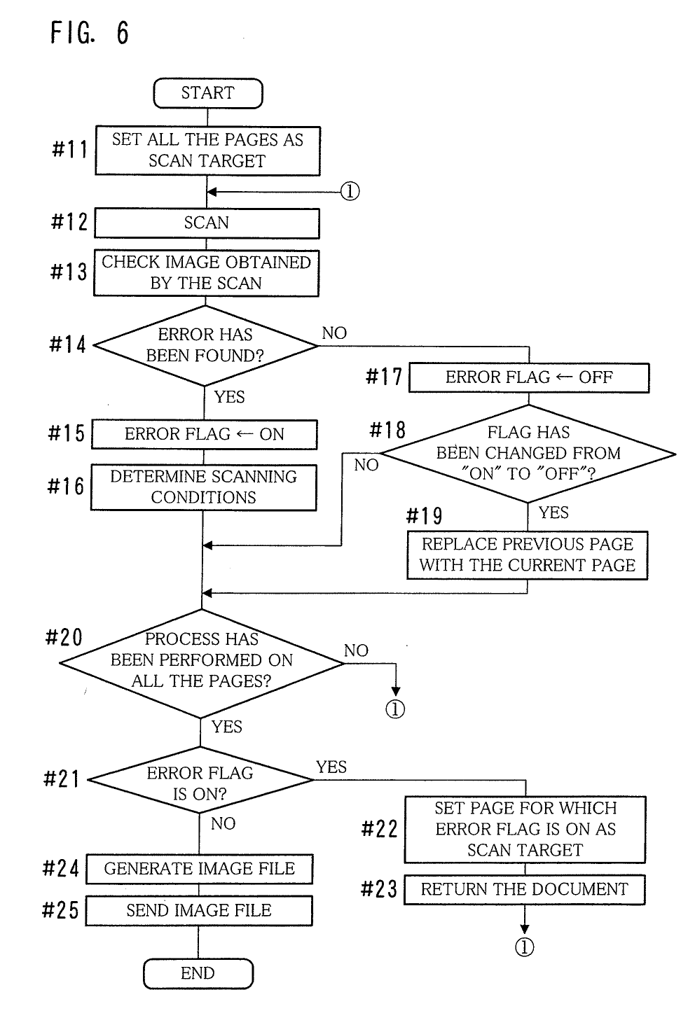

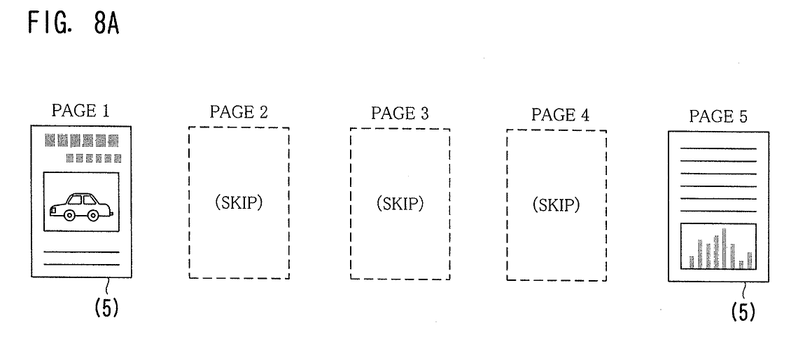

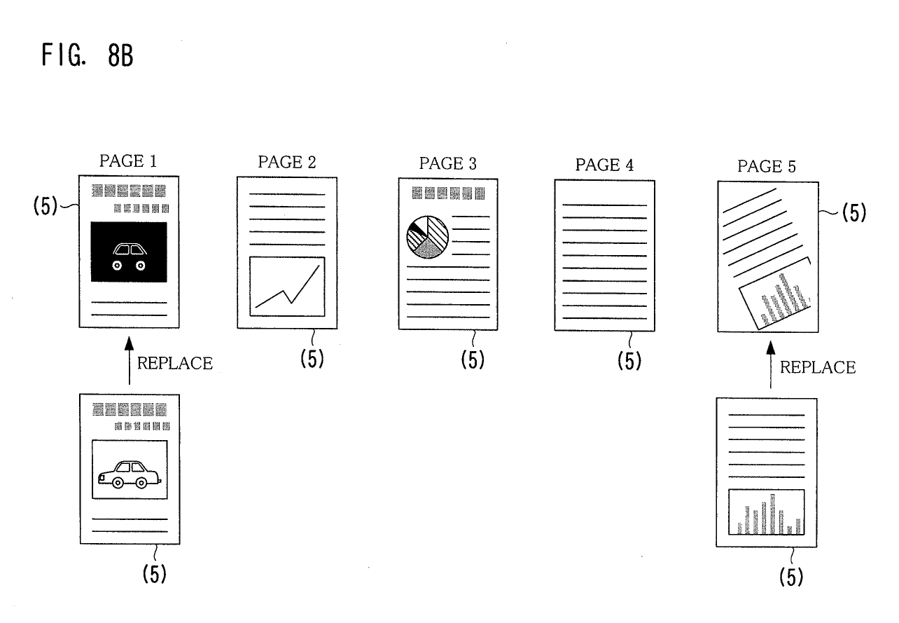

FIG. 6 is a flowchart illustrating an example of the overall processing flow of the image forming apparatus 1; FIGS. 7A-8B are diagrams depicting an example of steps for generating the image file 6.

An example of the steps of a scanning process in the image forming apparatus 1 is described below with reference to the flowchart of FIG. 6, and so on.

A user places, in the ADF 10j, the document 7 having the pages on each of which an image is depicted as shown in FIG. 7A. The user, then, operates the touchscreen 10h to specify a transmission destination, and enters a scan command.

Upon receiving the command, the image forming apparatus 1 performs a process according to the following procedure. The image forming apparatus 1, first, performs initial setting (#11 of FIG. 6). For example, the image forming apparatus 1 specifies, as the scan target, all the pages of the document 7. The number of pages of the document 7, however, is not known before the scanning process is started. Specifying all the pages of the document 7, thus, makes it possible to scan each page of the document 7 without skipping a page thereof as mentioned below. The image forming apparatus 1, then, sets conditions such as the scan density at a default value. Alternatively, the image forming apparatus 1 may set the conditions at a value specified by the user instead of the default value.

The image forming apparatus 1 reads an image on Page 1 based on the default conditions to generate image data 5 for Page 1, and stores the image data 5 therein (#12). At this time, the image forming apparatus 1 prepares page state information 4 (see FIG. 5) for Page 1.

The image forming apparatus 1, then, checks whether or not an error occurs in the image obtained by the scanning (#13). To be specific, the image forming apparatus 1 checks whether or not the image obtained by the scanning corresponds to the types of the errors mentioned earlier.

If it is found that an error occurs in the image (Yes in #14), then the image forming apparatus 1 updates the error flag of the page state information 4 for Page 1 to indicate “ON”, and updates the error type to indicate the type of the detected error (#15). Further, the image forming apparatus 1 determines conditions used for a scanning process to be performed once again due to the detection of the error in the image (hereinafter such a scanning process is referred to as a “further scanning process”) depending on the type of the error, and updates the scanning conditions to indicate the conditions determined (#16).

On the other hand, if it is found that no errors occur in the image (No in #14), then the image forming apparatus 1 updates the error flag of the page state information 4 for Page 1 to indicate “OFF” (#17).

If the current scanning process corresponds to a further scanning process and the error flag is changed from “ON” to “OFF” as a result of the further scanning process (Yes in #18), then the image forming apparatus 1 deletes the previous image data 5 on Page 1 which has been stored up to now, and newly stores the current image data 5 obtained through the current scanning process (#19). In short, the previous image data 5 is replaced with the current image data 5. Note that, for the first scanning process, the error flag is never changed from “ON” to “OFF”.

The image forming apparatus 1 performs, on images of Page 2 and beyond, the same process as that performed on the image of Page 1. As a result, assume that errors have been detected in images of Page 1 and Page 5 as illustrated in FIG. 7B.

If detecting an error in any of the pages of the document 7 (Yes in #21), then the image forming apparatus 1 sets once again, as the scan target, only pages on which an error has been detected, i.e., Page 1 and Page 5 in this example (#22), and supplies the document 7 back to the ADF 10j (#23). The image forming apparatus 1, then, performs the process from Step #12 through Step #19 appropriately. Note that, upon the scanning process, scanning conditions indicated in the page state information 4 corresponding to the page are used.

Likewise, the image forming apparatus 1 repeats the scanning process of pages on which an error has been detected until such time as an error is not detected in any of the pages.

Suppose that, as a result of the further scanning process on Page 1 and Page 5, image data 5 for images having no errors therein can be generated as shown in FIG. 8A. Then, the image forming apparatus 1, as shown in FIG. 8B, deletes the previous image data 5 for Page 1 and Page 5 generated before the further scanning process, and stores the current image data 5 generated for Page 1 and Page 5 through the further scanning process (Yes in #18, and #19). In short, the previous image data 5 is replaced with the current image data 5.

If no further errors are detected in the pages (No in #21), then the image forming apparatus 1 merges the image data 5 for each of the pages with one another to generate an image file 6 (#24). Thereafter, the image forming apparatus 1 sends the image file 6 generated to the transmission destination specified by the user (#25).

The embodiment discussed above makes it possible to obtain an error-free scan result for images depicted on a plurality of surfaces of a document more easily than is conventionally possible.

The embodiment describes an example in which the image forming apparatus 1 is provided with the document feedback mechanism 10k. Unless the image forming apparatus 1 is provided with the document feedback mechanism 10k, a user may carry, by hand, the document 7 that has been scanned by the scanner 10e to the ADF 10j.

In this embodiment, if an error occurs in an image obtained by scanning, e.g., if blocked up shadows appear or a vague image is found therein, the image forming apparatus 1 changes the scan density and performs a further scanning process. If an error other than those described occurs, the image forming apparatus 1 preferably changes conditions depending on the type of the error and performs a further scanning process. Suppose that, for example, an image obtained by a scanning process contains a text image indicating a text; however, an Optical Character Reader (OCR) function cannot be applied to the text image. In such a case, the image forming apparatus 1 preferably increases the resolution and performs a further scanning process.

In the case where an image obtained by scanning is inclined on a specific page a plurality of times through the repetition of the scanning process, the page is possibly folded. To cope with this, if an image obtained by scanning is inclined on a specific page a predetermined number of times, the image forming apparatus 1 preferably displays a message indicating the repeated occurrence of the error and a message for prompting the user to check the page. Further, if any other errors occur, the image forming apparatus 1 may display a message indicating the occurrence of the error.

The embodiment describes a case in which document data is depicted on only one surface of the paper. The embodiment is also applicable to a case in which document data is depicted on both surfaces of the paper. In such a case, an ADF compatible with double-sided scanning is preferably used as the ADF 10j and the scanner 10e preferably scans a plurality of sheets of paper in the following order: the front surface of the first sheet, the back surface of the first sheet, the front surface of the second sheet, the back surface of the second sheet, . . . the front surface of the N-th sheet, the back surface of the N-th sheet.

In the embodiments discussed above, the overall configurations of the network system NS, the configurations of various portions thereof, the content to be processed, the processing order, the configuration of the page state information 4, and the like may be altered as required in accordance with the subject matter of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A method for generating image data of a document by reading an image depicted on the document, the document having a plurality of surfaces to be read, the method comprising:
a first step of reading, by an image reader, a surface image that is an image depicted on each of the plurality of surfaces;
a second step of detecting, by an error detector, a faulty surface that is a surface of the plurality of surfaces of the document and corresponds to a scanned image on which an error occurs, the scanned image being obtained by reading the surface image;
a third step of reading, by the image reader, the surface image repeatedly until the error is not detected; and
a fourth step of generating, by an image data generating portion, the image data by merging data on the plurality of the scanned images on which the error is not detected and which correspond to the plurality of surfaces.

2. The method according to claim 1, wherein
the first step includes placing the plurality of surfaces in the image reader by feeding the document successively to the image reader by an automatic document feeder, and reading, by the image reader, the surface image depicted on said each of the plurality of surfaces, and
the third step includes placing the plurality of surfaces in the image reader by feeding the document successively to the image reader by the automatic document feeder, reading, by the image reader, only the surface image depicted on the faulty surface, and skipping reading the surface images depicted on the plurality of surfaces except the surface image depicted on the faulty surface.

3. The method according to claim 2, further comprising a fifth step of feeding, by a document feedback mechanism, the document to the automatic document feeder after the image reader reads the surface image depicted on said each of the plurality of surfaces.

4. The method according to claim 1, wherein the third step includes changing conditions depending on the error found on the scanned image corresponding to the faulty surface, and reading the surface image depicted on the faulty surface by the image reader.

5. An apparatus for generating image data of a document by reading an image depicted on the document, the document having a plurality of surfaces to be read, the apparatus comprising:
a reader that reads a surface image that is an image depicted on each of the plurality of surfaces;
an error detector that detects a faulty surface that is a surface of the plurality of surfaces of the document and corresponds to a scanned image on which an error occurs, the scanned image being obtained by reading the surface image;
a reader controller that controls the reader to read the surface image repeatedly until the error is not detected; and
an image data generating portion that generates the image data by merging data on the plurality of the scanned images on which the error is not detected and which correspond to the plurality of surfaces.

6. The apparatus according to claim 5, further comprising a document feeder that places the plurality of surfaces in the reader by feeding the document successively to the reader,
wherein the reader reads the surface image depicted on said each of the plurality of surfaces thus fed successively, and
the reader controller controls the document feeder to place the plurality of surfaces in the reader once again by feeding the document to the reader until the faulty surface is not detected, and controls the reader to read only the surface image depicted on the faulty surface, and to skip reading the surface images depicted on the plurality of surfaces except the surface image depicted on the faulty surface.

7. The apparatus according to claim 6, further comprising a document feedback mechanism that feeds the document to the document feeder after the reader reads the surface image depicted on said each of the plurality of surfaces.

8. The apparatus according to claim 5, wherein the reader controller changes conditions depending on the error found on the scanned image corresponding to the faulty surface, and controls the reader to read the surface image depicted on the faulty surface.

9. A computer-readable storage medium storing thereon a computer program used in an apparatus for generating image data of a document by reading an image depicted on the document, the document having a plurality of surfaces to be read, the computer program causing the apparatus to perform:
a first process of reading a surface image that is an image depicted on each of the plurality of surfaces;
a second process of detecting a faulty surface that is a surface of the plurality of surfaces of the document and corresponds to a scanned image on which an error occurs, the scanned image being obtained by reading the surface image;
a third process of reading the surface image repeatedly until the error is not detected; and
a fourth process of generating the image data by merging data on the plurality of the scanned images on which the error is not detected and which correspond to the plurality of surfaces.

10. The computer-readable storage medium according to claim 9, wherein
the apparatus is connected to a document feeder and an image reader,
the first process includes controlling the document feeder to place the plurality of surfaces in the image reader by feeding the document successively to the image reader, and controlling the image reader to read the surface image depicted on said each of the plurality of surfaces, and
the third process includes controlling the document feeder to place the plurality of surfaces in the image reader by feeding the document successively to the image reader, and controlling the image reader to read only the surface image depicted on the faulty surface, and to skip reading the surface images depicted on the plurality of surfaces except the surface image depicted on the faulty surface.

11. The computer-readable storage medium according to claim 10, wherein
the apparatus is connected to a document feedback mechanism, and
the computer program causes the apparatus to perform a fifth process of controlling the document feedback mechanism to feed the document to the document feeder after the image reader reads the surface image depicted on said each of the plurality of surfaces.

12. The computer-readable storage medium according to claim 9, wherein the third process includes controlling the image reader to change conditions depending on the error found on the scanned image corresponding to the faulty surface, and to read the surface image depicted on the faulty surface.
